(19) United States
(12) Patent Application Publication
(10) Pub. No.: US 2010/0065996 A1
(43) Pub. Date: Mar. 18, 2010

(54) TWO-LAYER OR MULTIPLE-LAYER COMPRESSION SPRING

(75) Inventors: Andreas Hohl, Rüti (CH); Hans Notenboom, Rapperswil (CH)

Correspondence Address: BREINER & BREINER, L.L.C., P.O. BOX 320160, ALEXANDRIA, VA, 22320-0160, US

(73) Assignee: Bauman Federn AG, Ruti (CH)

(21) Appl. No.: 12/449,194

(22) PCT Filed: Jan. 29, 2007
(86) PCT No.: PCT/EP2007/050839

§ 371 Date: Jul. 28, 2009

(51) Int. Cl. F16F 3/06

(52) U.S. Cl. 267/168

(57) ABSTRACT

A multiple-layer compression spring having spring bodies that are disposed inside of each other wherein the spring bodies are produced in a continuous manner from an uninterrupted piece of wire.

The present invention refers to a two or multi-layer compression spring, the cylindric spring bodies of which are disposed inside each other.

Energy has to be stored very often over a longer period, but should not be lost over the time period and it should be possible to be delivered purposeful at a certain point of time.

For this purpose very often compressed air, hydraulic or spring storages are used. Spring operating storages do have the advantage that they are simply constructed and at right dimensioning to have none or only a very restricted force or energy loss respectively. This energy loss can be further reduced by a respective dimensioning of the spring with a respective low charge below the creep limit of the material. A low utilisation of the charge of the material, however, leads to the requirement of a bigger necessary construction volume.

A further aspect of an energy storage, in particular a spring energy store, is the characteristic of the spring force over the decompression path of the spring:

Compact spring energy stores with a high initial force usually have a high spring rate with a high starting force and a low end force. Due to the high starting force, the force collecting construction parts must be disproportional strongly dimensioned so that the end force still reaches the required value. In addition, at a bad ratio of the starting force to the end force the function of the construction part intaking the force can be affected. To fulfil the requirement to a flat spring characteristics, results to a bigger required construction volume for the spring energy store.

The requirement for more energy storing per volume has been solved e.g. by introducing into each other two or more springs with different diameter, to better use the existing construction volume.

According the requirements, these springs have to be hold against each other. This can be done with different methods, e.g. by means of a jacket, which is introduced between the springs or by means of spring plates, which are positioned and locked on the spring ends. Jackets or spring plates should prevent that the springs are grating to one another or are even got stuck into each other. Besides the fact that with these approaches to the problem, an effort occurs in relation to the assembling, the result is not always sufficient.

The object of the invention is to fulfil the requirements more optimal and to eliminate or at least to reduce the disadvantages of known solutions.

The mentioned object is inventively solved by a compression spring of the initially defined manner, according the feature of the characterizing part of claim 1. Especially preferred embodiments of the inventive subject are defined within the dependent claims.

The invention is described hereafter by means of example of embodiments in more details, which are shown within the figures.

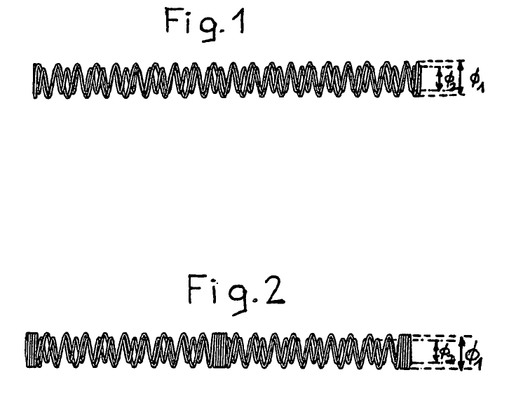

FIG. 1 shows an inventive compression spring, made out of two spring bodies disposed inside each other, which consist out of a single, which means interrupt-less piece of a wire, and

FIG. 2 a similar compression spring as shown in FIG. 1, at which however in the middle of the spring length and at the spring ends, windings are provided, which are arranged tightly one to another.

The compression spring as shown in the Figures, comprises two spring bodies 1, 2 made out of spring steel, which are disposed inside of each other, which do have different diameters, but are made out of a single, which means an interruption free piece of wire. The intersection between spring body 1 with the bigger diameter onto the spring body 2 with the smaller diameter, which means the connection between the two spring bodies takes place at one spring end. The fabrication of such a multi-layer spring is known to the specialist.

FIG. 2 shows an embodiment of a two-layer spring, of which the two spring bodies 1, 2 comprise inclinations in opposite directions, (as preferably also the spring according FIG. 1) what minimizes the inside disposal of the individual spring bodies, and which at various portions comprise to one another abutting windings, what reduces the interacting friction between the spring bodies and as a consequence a chattering at the spring tuning or even the risk of a hanging between the springs.

By means of the inventive very simply constructed spring, the essential disadvantages of known solutions can be avoided.

1. (canceled)

2. (canceled)

3. (canceled)

4. (canceled)

5. Compression spring having more than one layer comprising a plurality of cylindric spring bodies arranged one inside another, wherein the spring bodies are composed of an uninterrupted piece of wire.

6. The compression spring according to claim 5, wherein each of the spring bodies comprises windings with an inclination in an opposite direction.

7. The compression spring according to claim 5, wherein each of the spring bodies, at one or more sections along a length thereof and/or at least at one end thereof comprises abutting windings.

8. The compression spring according to claim 6, wherein each of the spring bodies, at one or more sections along a length thereof and/or at least at one end thereof comprises abutting windings.

9. The compression spring according to claim 5, wherein the wire of the spring bodies comprises a cross-section of any size.

10. The compression spring according to claim 6, wherein the wire of the spring bodies comprises a cross-section of any size.

11. The compression spring according to claim 7, wherein the wire of the spring bodies comprises a cross-section of any size.

12. The compression spring according to claim 8, wherein the wire of the spring bodies comprises a cross-section of size order.
